(19) United States
(12) Patent Application Publication
(10) Pub. No.: US 2014/0246489 A1
(43) Pub. Date: Sep. 4, 2014

(54) CONSTRUCTION MATERIAL MANAGEMENT DATA RECORDING SYSTEM AND PLYBOARDS TO BE USED AS A MOLDS FORMING CONCRETE FOR THE SYSTEM

(71) Applicant: MITOMO CORPORATION, Kanagawa (JP)

(72) Inventor: Kikuo KAGA, Tokyo (JP)

(73) Assignee: MITOMO CORPORATION, Kanagawa (JP)

(21) Appl. No.: 13/948,277

(22) Filed: Jul. 23, 2013

(30) Foreign Application Priority Data
Mar. 1, 2013 (JP) 2013-40853

(51) Int. Cl. G06Q 10/08

(52) U.S. Cl. CPC G06Q 10/0875
USPC 235/376

(57) ABSTRACT

A system, which can make possible to record the management data of construction materials without separating said data from the construction materials themselves and to check those data at any time, is provided.

For achieving the foresaid object, a system is constituted such that it comprising an IC tag 3 of the non-contacting type to be attached to a construction material 1, 4 and a reader-writer 10 for writing data to and read data from said IC tag 3, wherein at least the management data of said construction material is written to or red from said IC tag 3.

### FIELD OF THE INVENTION

The present invention relates to a system for recording data on the management of construction materials, in particular to a system for recording data on the management of plyboards used as a mold for forming concrete.

### BACKGROUND ART

Materials used for constructions of buildings and structures are broadly-divided into two categories of materials, that is, the structural materials used for e.g. columns, floors and the like, which are remained as the structures after the completion of construction, and the building materials used as e.g. plyboards to be used for a mold for forming concrete, which are adapted to be removed from the constructed structures after the completion of construction. Generally, the construction materials such as lumbers are processed by cutting, laminating, antiseptic treatment and the like, at the factories of manufacturers of construction materials which have been approved in accordance with the official industrial standards, the processed construction materials are inspected for performance as the lumbers, and the inspected materials are then distributed to the wholesale dealers together with the inspection results. The wholesale dealer handling the construction materials receives an order from a builder to carry necessary types and shapes of construction materials to the building site. The builder uses the construction materials carried to the building site to carry out construction. Among this sort of construction materials, the performance and strength of the structural materials are naturally important since the structural materials are remained as the part of the building and the structures. Besides, the degrees of performance and strength of the building materials like the plyboards to be used as a mold for forming concrete which are adapted to be removed from the structures is equally important because those materials also give an influence on the strength of the structures. However, the data with regard to the adaptability to the industrial standards for this sort of construction materials and the grades of the construction materials has been kept by only the manufacturers and wholesale dealers of those construction materials in the form of papers. Consequently, it is appreciated that there is few chance for the parties concerned with the built structures, such as the manufacturers and wholesale dealers of the construction materials, the builders, the house suppliers and the end users, to read and check said data as one allowable to read at any time. Besides, the plyboard to be used as a mold for forming concrete is generally used in a repeated manner after being removed from a structure as far as it can survive through extensive use, and the limit of durability of the plyboard is determined in many cases on the basis of experience and visual check by the builders.

Note that, in the prior art with regard to the construction materials, a mechanism adapted to detachably attach an IC tag to a lumber to be processed by precutting is disclosed as a system for attesting the structural material embedded with an IC tag at the building site (see Patent Documents 1 and 2). Furthermore, a management method for controlling raw timber by means of using an IC tag is also disclosed (see Patent Document No. 3). Besides, with respect to the plyboard to be used as a mold for forming concrete, various structures have been proposed in order to improve the solidity, the adaptability for being nailed, etc. at the time of casting concrete (see Patent Reference Nos. 4, 5 and 6). On the other hand, the miniaturization and weight-saving of the IC tag have been achieved in recent years.

### REFERENCE OF THE PRIOR ART

Patent Documents

### [Patent Document 1]: Japanese Unexamined Patent Application Publication No. 2009-12407

### [Patent Document 2]: Japanese Unexamined Patent Application Publication No. 2012-27947

### [Patent Document 3]: Japanese Unexamined Patent Application Publication No. 2007-26415

[Patent Document 4]: Japanese Unexamined Patent Application Publication No. Hei 6-297435
[Patent Document 5]: Japanese Unexamined Patent Application Publication No. Hei 7-189482

### [Patent Document 6]: Japanese Unexamined Patent Application Publication No. 2000-154644

[Patent Document 7]: International Patent Application Publication No. WO2008/053702

### DESCRIPTION OF THE REFERENCE NUMERALS

1: Plyboard to be used as a mold for forming concrete
2, 21, 22, 23: Board
3: Wireless IC tag
30: Wireless IC tag main body
31: Ferrite core
32: IC chip
33: Antenna
34: Protective member
35: End surface of protective member
4: Plyboard to be used as a mold for forming concrete
5, 51, 52, 53: Board
61: Reinforcing material
62: Reinforcing bar
7: Part for joining
81: Pedestal
82: Pile
9: Computing apparatus
91: Display
10: Reader-writer
11: Data communication section
12: Server
101: Fresh concrete

### SUMMARY OF THE INVENTION

Although a certain type of tag and system, with which lumbers can be authenticated, have been proposed in the above-referenced Patent Documents 1 and 2, it is merely a system that authenticates whether there is no error in the combination of lumbers at the building site or not and are not a system that can check such performance or records of lumbers that if the construction material complies with the required specification or not, or the number of times of use of the lumbers is within the acceptable range of the durability or not. Moreover, among construction materials, there is no description on the system adapted to manage construction materials to be removed from the structure after completion of the construction, such as plyboards to be used as a mold for forming concrete.

Therefore, it is an object of the present invention to provide a system which can record data on management of construction materials and check the data at any time without separating said data from the construction materials themselves.

Further, it is also an object of the present invention to provide a system which can firmly manage construction materials, particularly those to be removed from the structure after completion of the construction.

According to the present invention, the construction material management data recording system comprising an IC tag of the non-contacting type and being attachable to a construction material and a reader-writer adapted to carry out writing and reading data with respect to the IC tag is provided, and said system is characterized in that the data on at least the management of construction materials are written to and read from the IC tag.

According to another embodiment of the present invention, the construction material is a plyboard made by bonding either lumber boards or synthetic resin boards to each other, characterized in that an IC tag is attached to the minimum unit member of said plyboard to be used as a mold for forming concrete.

Further, the wireless IC tag is characterized in that it is attached to a plyboard to be used as a mold for forming concrete so as to be fixed to the surface of said plyboard.

Alternatively, the wireless IC tag is characterized in that it is attached to a plyboard to be used as a mold for forming concrete so as to be embedded in said plyboard.

Still further, the management data to be recorded in the IC tag is characterized by including at least anyone of construction material performance data, construction material history data and construction material positioning data.

Still further, the system according to the present invention is characterized in that it comprises a computer being connectable with the reader-write, and that the management data is associated with the display format stored in the computing apparatus and then processed so as to be displayable on a display.

Still further, according to the present invention, the plyboard to be used as a mold for forming concrete, characterized in that said plyboard is made by bonding either lumber boards or synthetic resin boards to each other and is provided with an IC tag in which management data on the construction materials used is recorded, is provided.

According to the construction material management data recording system of the present invention, the management data on construction materials can be managed without separating said data from the construction materials themselves.

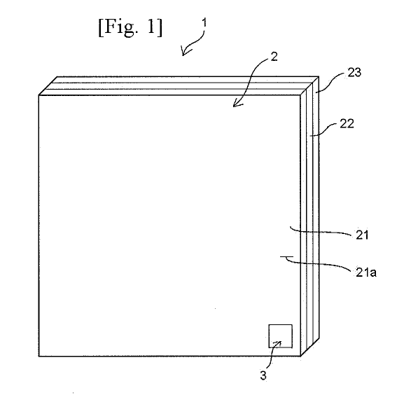

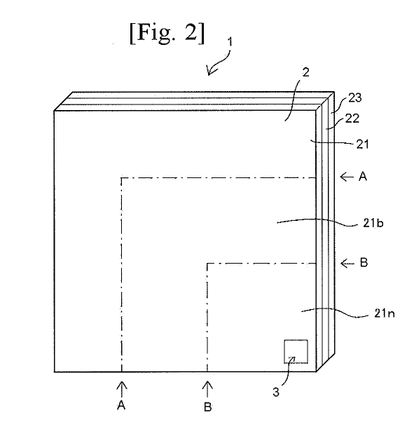

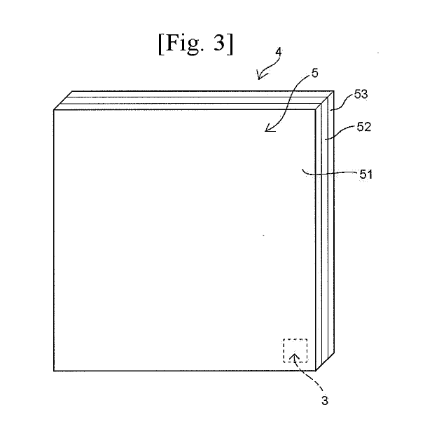

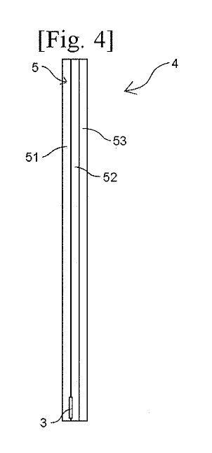

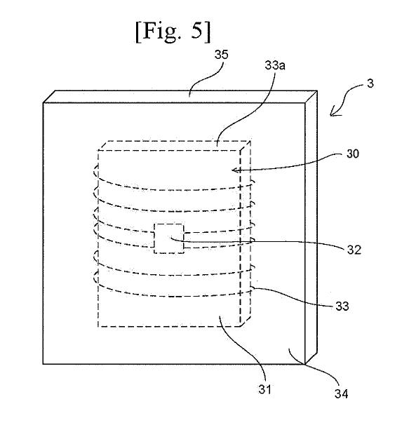

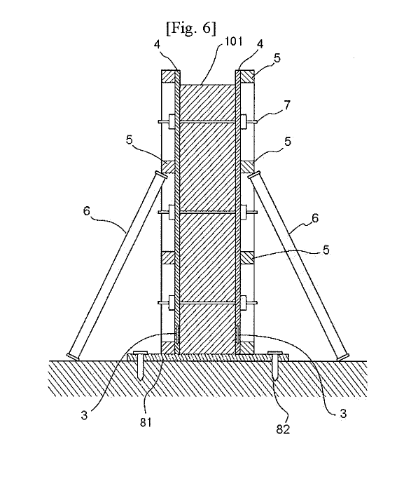

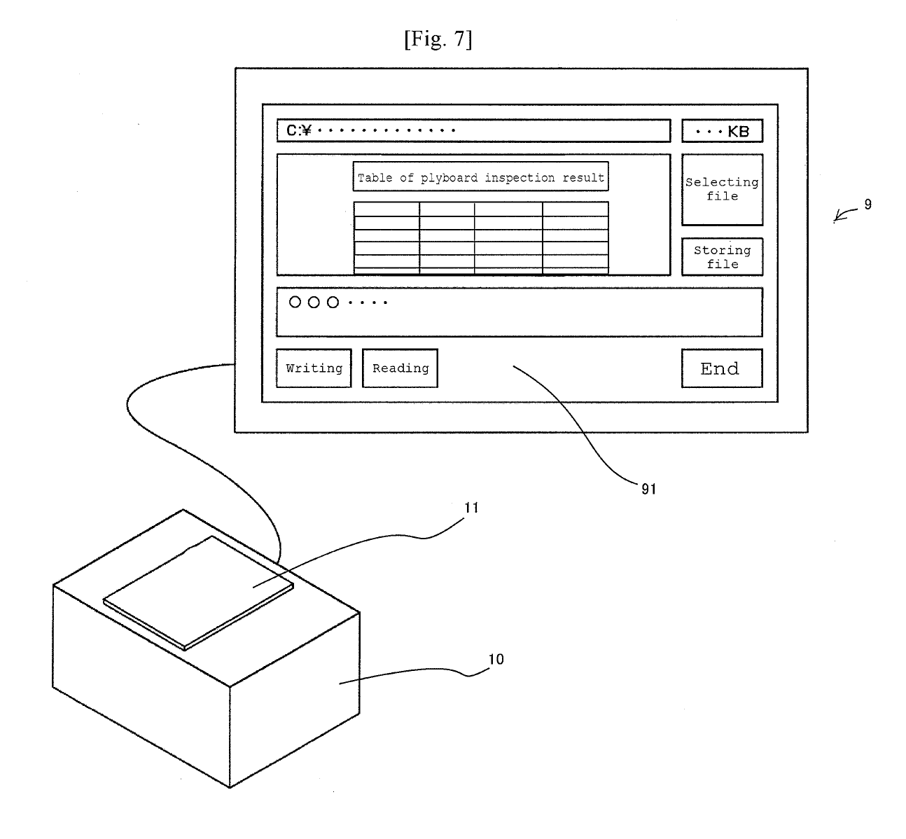

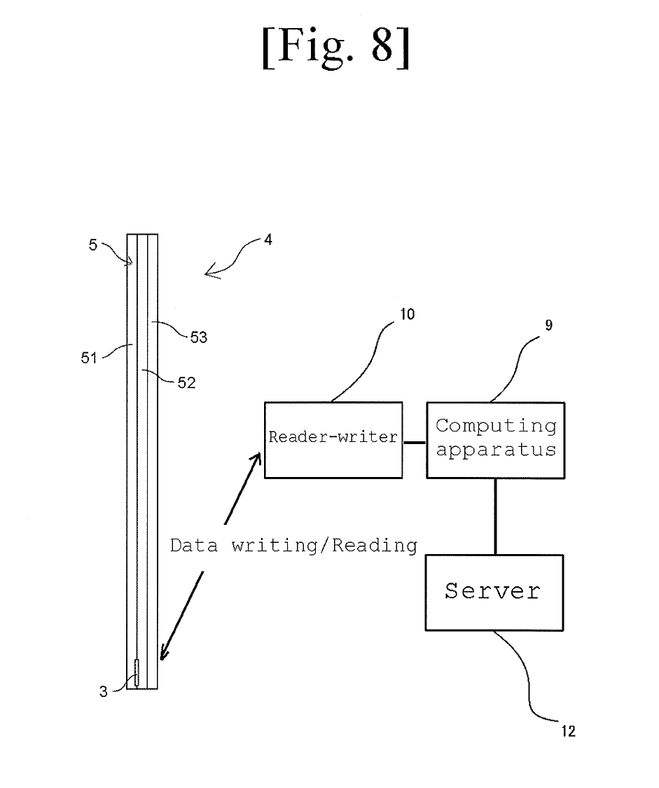

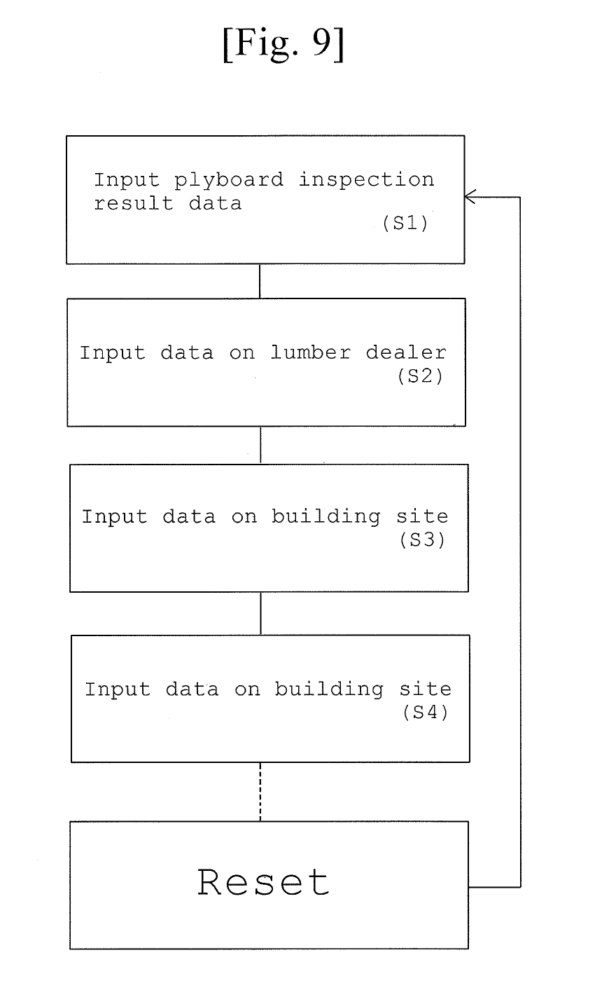

### BRIEF DESCRIPTION OF THE DRAWINGS

[FIG. 1] A perspective view of a plyboard to be used as a mold for forming concrete according to the first embodiment, which is used for realizing the construction material management data recording system of the present invention.

[FIG. 2] A perspective view showing examples of cutting of the plyboard used to be as a mold for forming concrete shown in FIG. 1.

[FIG. 3] A perspective view showing a plyboard to be used as a mold for forming concrete according to the second embodiment, which is used for realizing the construction material management data recording system of the present invention.

[FIG. 4] A longitudinal cross-section of the plyboard to be used as a mold for forming concrete shown in FIG. 3.

[FIG. 5] A schematic perspective view of an IC tag to be used for the construction material management data recording system according to the present invention.

[FIG. 6] A cross-section showing an assembled example of the plyboard to be used as a mold for forming concrete shown in FIG. 2.

[FIG. 7] A set of a reader-writer and a computing apparatus to be used for realizing the construction material management data recording system according to the present invention.

[FIG. 8] A block diagram schematically showing the construction material management data recording system according to the present invention.

[FIG. 9] A flow chart illustrating the operations executed according to the construction material management data recording system according to the present invention.

### DETAILED DESCRIPTION OF THE PREFERRED EMBODIMENTS

Now, the detail of the present invention is specifically described by using the various examples described hereinbelow with referring to the appended drawings. Note that, in all of the examples described below, although an IC tag is attached to the plyboard to be used as a mold for forming concrete, the construction material management data recording system according to the present invention may be applied naturally to the structural materials, such as materials used for columns, floors and so on.

As shown in FIGS. 1 through 8, the construction material management data recording system according to the present invention comprises a wireless IC tag 3 of the non-contacting type adapted to be attached to a construction material 1, 4, a reader-writer 10 for writing data to and reading data from said wireless IC tag 3 and a computer working as a computing apparatus 9 and being connected to said reader-writer 10 either in a wired or wireless manner. Furthermore, the system is also provided with a computing apparatus 9 and a server 12 to which accesses from an external terminal (not shown) is allowed upon requirement.

### EXAMPLES

### Example 1

With reference to FIGS. 1 and 2, the plyboard 1 to be used for a mold for forming concrete according to the first embodiment in order to realize the construction material management data recording system of the present invention will be explained below. The plyboard 1 as a construction material to be used for a mold for forming concrete is a plyboard, also called as “concrete panel”, to be used for a mold, with which casting of concrete is carried out. The plyboard 1 to be used for a mold for forming concrete is made by bonding boards 21-23 made of lumbers or synthetic resin boards one another, and the boards 21-23 have been subjected to various treatments including preservative treatment.

In the surface 21a of the board of the plyboard 1 to be used for a mold for forming concrete, which positions during the use at the side opposite to the side to which fresh concrete will be poured, a wireless IC tag 3 is fixed by means of adhesion, pressure joining or the like.

The wireless IC tag 3 to be fixed to the plyboard 1 being used as a mold for forming concrete is a tag of the non-contacting type for radio communication use, which is also called as RFID tag, and is adapted to carry out writing data to and reading data from the data communication section 11 of the reader-writer 10.

An example of the wireless IC tag 3 is shown in FIG. 5. The wireless IC tag 3 comprises a protective member 34 made of resin in which an IC tag main body 30 is enclosed inside the protective member 34. The wireless IC tag 30 is an RFID tag, which is constituted by mounting an IC chip 32 in a ferrite core 31 and connecting the IC chip with an antenna coil 33, said IC chip comprising a non-volatile memory, a controller, a modem and a power source for receiving radio waves from the exterior to resonate therewith to thereby generate current. Note that the protective member 31, though it aims at preventing the IC tag main body from wetting, corrosion and so on, is preferably formed as thin as possible so that no adverse effect is applied to the plyboard 1 to be used as a mold for forming concrete, which will be attached with the protective member 34. At the same time, the protective member 31 is preferably made of an alkali-resistant material for preventing it from being damaged when it contacts with strong alkaline fresh concrete. As an example of the alkali-resistant material, polyamide resins and polypropylene resins can be specified.

Besides, since the wireless IC tag 3 has directivity in the direction perpendicular to the winding direction of the antenna 33, the wireless IC tag 3 is preferably fixed to the plyboard 1 to be used as a mold for forming concrete such that the end surface (33a, 35) opposed to the wireless IC tag 3 is positioned at the end surface side of the plyboard 1 to be used as a mold for forming concrete.

In general, the plyboard 1 to be used for a mold for forming concrete is removed from the structure when the use thereof is finished at the building site, and it is then used repeatedly over a period of its endurance. At each time of removing the plyboard from the structure, the plyboard 1 may be cut depending upon the size of the structure used and the casting site of concrete. As shown in FIG. 2, the whole of the plyboard 1 to be used for a mold for forming concrete is used in the first building site, the plyboard 1 is cut through a line A-A and the surface 21b of the plyboard 1 is used in the next building site, and the plyboard 1 is cut through a line B-B and the surface 21n of the plyboard 1 is used in the final building site. Consequently, the wireless IC tag 3 is preferably attached to the minimum unit member 21n of the plyboard 1 to be used as a mold for forming concrete.

### Example 2

With reference to FIGS. 3 and 4, the plyboard 4 to be used as a mold for forming concrete according to the second embodiment in order to realize the construction material management data recording system of the present invention will now be explained below. The plyboard 4 to be used for a mold for forming concrete is made as a construction material by bonding boards 51 to 53 one another, which comprises lumbers, synthetic resin boards or the like.

In the part of the plyboard 4 to be used for a mold for forming concrete where said boards 51 to 53 are bonded one another, an IC tag 3 is contained by means of embedding in the concave provided in the board body formed by bonding. Note that the configuration of the wireless IC tag 3 is same as that shown in Example 1, and description on the wireless IC tag 3 shall be therefore omitted here.

The plyboard 4 to be used as a mold for forming concrete as well may be cut for the use similarly to the plyboard 1 to be used as a mold for forming concrete. Therefore, taking opportunity of cutting in consideration, the plyboard 4 to be used as a mold for forming concrete is preferably attached to the minimum unit member of the plyboard 4.

Next, with reference to FIG. 6, a use example of the plyboard 4 to be used for a mold for forming concrete will be explained hereinbelow. A pair of plyboard 4 is reinforced by means of a reinforcing member called “crosspiece”, and the lower end of the reinforcing member is then fixed on a pedestal 81 using spiles 82. At this stage, both plyboards 4 are fixed with joint members 7 while securing a required distance for pouring concrete in between the plyboards 4. On this occasion, the plyboards 4 may be supported with supporting bars 62 for preventing the plyboard 4 from falling. A concrete structure is casted and built by pouring fresh concrete 12 in between the plyboards 4 to be used as a mold for forming concrete. Following to the hardening of the poured fresh concrete 12, said plyboards 4 to be used for a mold for forming concrete will be removed.

Through the process as described above, a concrete structure is casted and built. When the strength of the plyboards 4 to be used for a mold for forming concrete is high and the warp thereof is less, a structure with appropriate thickness can be made, because no warp will be occurred in both sides of the plyboards 4. When the strength of the plyboards 4 is less and the warp thereof is great on the other hand, a structure with appropriate thickness cannot be made because the both sides of the plyboards 4 will be warped. Consequently, the performance and the uses within the durable use times of the plyboards 4 to be used for a mold for forming concrete are important factors for selecting the plyboard 4 and it affects the safeness of the concrete structure. Of course, the performance of construction materials other than the plyboards 4 to be used as a mold for forming concrete affect the safeness of the concrete structure as well.

### Example 3

With reference to FIGS. 7 through 9, the construction material management data recording system, which uses the plyboards 1 to be used as a mold for forming concrete as the construction material described above, a reader-writer 10 and a computing apparatus 9, will now be explained. The wireless IC tag 3 attached to the plyboard 1, 4 to be used for a mold for forming concrete is adapted to turn to the electrogenic condition, then to write data to and read data from a memory of an IC chip 32, when the reader-writer is accessed to the available communication range. When management data and the classification code of the management data are inputted to the computing apparatus 9, the computing means of the computing apparatus 9 writes the management data and its classification code to the wireless IC tag 3 by means of the reader-writer 10. Yet, when reading instruction is inputted from the computing apparatus 9, the reader-writer 10 is adapted to read the management data having been written to the wireless IC tag together with the classification code, the computing means of the computing apparatus 9 is adapted to associate the read management data with the display format established in connection with the respective classification code to process the read management data to the displayable form, and the display means is adapted to display said data on a display apparatus 91.

Examples of the management data to be written and read and the flow of said writing in the construction material management data recording system will now be explained with reference to FIG. 9. During the manufacturing stage of the construction material, the wireless IC tag 3 is attached to the construction material (a plyboard 1, 4 to be used as a mold for forming concrete in this Example). Also, during the manufacturing stage of the construction material, plyboard inspection results as being the construction material performance data are written to the wireless IC tag 3 (S1). The contents of data on the plyboard inspection results are consisted of e.g. inspection admission numbers, date of inspection, classification of product (e.g. plyboard used as a mold for concrete wall processing), name of inspector, a type of lumber (e.g. Lauan Lumber, Cypress wood, etc.), number of layers of a plyboard (ex. 3 layers, 5 layers, etc.), grade, method of surface processing, names of chemicals used, dimension, thickness, actual construction material performance test results including bending stiffness test, peel property test, tension test, moisture content test, temperature cycle test, resistance test against alkalis, etc., a certificate that verifies compliance to approval criteria of industrial standards, and a classification code that verifies that the inputted data is the inspection result data of the plyboard.

Next, at the stage where the construction material is distributed to a wholesale dealer, a data on lumber dealer as the record data of the first construction material is written to the wireless IC tag 3 (S2). The data on lumber dealer is consisted of e.g. date of purchase, name of lumber dealer, method of storage, etc. and classification code that indicates that the inputted data is a data of lumber dealer. As described later, the plyboard inspection result data written to the wireless IC tag 3 in the previous stage may be read at the place of the lumber dealer.

Next, at the stage where the construction material is used in the building site, data of the building site as the second construction material record data is written to the wireless IC tag 3 (S4). The building site data is consisted of e.g. date of installation of construction materials, name of builder, construction technique, etc. and classification code that indicates that the inputted data is the building site data. Accumulation of the building site data is accomplished at every repeated uses of the construction materials (S4 to Sn). Note that, as described later, plyboard inspection result data and lumber dealer data both having been written to the wireless IC tag 3 in the previous stage may be read at the building site.

As described above, the construction material performance data and the construction material record data are stored in the wireless IC tag 3, and these data may be written to the falsification prevention domain of the wireless IC tag 3 so that neither falsification nor initialization of the data can be caused until the collection stage of the construction materials in order to prevent falsification of data from occurring. In addition, the wireless IC tag 3 may be reset by inputting a predetermined pass code at the stage where the construction materials are eventually discarded, so that the reuse of the wireless IC tag 3 may be effected.

Now, the flow of reading the management data in the construction material management data recording system according to the present will be explained below. When the management data is read from the wireless IC tag 3, the processing means in the computing apparatus 9 executes processing to associate the management data being read based on the classification code contained in the management data with the display format. For instance, the construction material performance data of the plyboard inspection result data is associated with the predetermined column of the plyboard inspection result table format. Further, the certificate data is associated with the image display column of the plyboard inspection result format. The display means of the computing apparatus 9 displays these data on the display apparatus 91 in such a state that the data is associated with the display format. Therefore, a reader can read the table of the plyboard inspection result and the certificate, and can print the table of plyboard inspection result and the certificate as necessary.

Alternatively, the system according to the present invention may be provided with a server 12 which allows access from the computing apparatus 9 and the external terminal (not shown)to thereby concentrate the management data inputted at each stage to the server 12.

Furthermore, the construction material positioning data for representing the arrangement position and assembly method of construction materials at the building site may be included in the management data. Still further, the construction material positioning data may be written to the rewritable domain of the memory to so that new construction material positioning data may be rewritten at every building site.

As described above, the user of the system according to the present invention is enabled to write the construction material performance data and the construction material record data to the wireless IC tag 3 at each stage and to read data of the previous stages only by causing the reader-writer 10 to be close to the construction material to operate the computing apparatus 9. Accordingly, with the system according to the present invention, it is made possible to provide the system which can manage the construction material performance data and the construction material record data of the construction materials, particularly the plyboard 1, 4 to be used as a mold for forming concrete without separating those data from the plyboard 1, 4 itself and to achieve securement of safeness of the construction materials and the structure comprising the construction materials and improvement of liability. Furthermore, writing the construction material positioning data in addition to the above-described data will make possible to provide the system which achieve the positioning and assembly of the construction materials with no error and to enhance the certainty and swiftness of building process.

1. Construction material management data recording system comprising an IC tag of the non-contacting type to be attached to a construction material and a reader-writer for writing data to and reading data from the IC tag, wherein at least the management data of said construction material is written to and read from said IC tag.

2. Construction material management data recording system according to claim 1, wherein the construction material is a plyboard to be used as a mold for forming concrete, which is made by bonding either wood boards or synthetic resin boards and an IC tag is attached to the minimum unit member of said plyboard to be used as a mold for forming concrete.

3. Construction material management data recording system according to claim 1, wherein the wireless IC tag is attached in such a manner that it is fixed on the surface of the plyboard to be used as a mold for forming concrete.

4. Construction material management data recording system according to claim 1, wherein the wireless IC tag is attached in such a manner that it is embedded in the plyboard to be used as a mold for forming concrete.

5. Construction material management data recording system according to claim 1, wherein the management data to be stored in the wireless IC tag contains at least any of construction material performance data, construction material record data and construction material positioning data.

6. Construction material management data recording system according to claim 1, wherein the system comprises a computing apparatus being connectable with the reader-writer, and the management data is associated with the display format stored in said computing apparatus and is then processed so as to be displayable on a display.

7. A plyboard to be used as a mold for forming concrete, characterized in that the plyboard is made by bonding either wood boards or synthetic resin boards and is then attached thereon with an IC tag, in which the management data of construction materials are stored.

8. Construction material management data recording system according to claim 2, wherein the wireless IC tag is attached in such a manner that it is fixed on the surface of the plyboard to be used as a mold for forming concrete.

9. Construction material management data recording system according to claim 2, wherein the wireless IC tag is attached in such a manner that it is embedded in the plyboard to be used as a mold for forming concrete.

10. Construction material management data recording system according to claim 2, wherein the management data to be stored in the wireless IC tag contains at least any of construction material performance data, construction material record data and construction material positioning data.

11. Construction material management data recording system according to claim 3, wherein the management data to be stored in the wireless IC tag contains at least any of construction material performance data, construction material record data and construction material positioning data.

12. Construction material management data recording system according to claim 4, wherein the management data to be stored in the wireless IC tag contains at least any of construction material performance data, construction material record data and construction material positioning data.

13. Construction material management data recording system according to claim 8, wherein the management data to be stored in the wireless IC tag contains at least any of construction material performance data, construction material record data and construction material positioning data.

14. Construction material management data recording system according to claim 9, wherein the management data to be stored in the wireless IC tag contains at least any of construction material performance data, construction material record data and construction material positioning data.

15. Construction material management data recording system according to claim 2, wherein the system comprises a computing apparatus being connectable with the reader-writer, and the management data is associated with the display format stored in said computing apparatus and is then processed so as to be displayable on a display.

16. Construction material management data recording system according to claim 3, wherein the system comprises a computing apparatus being connectable with the reader-writer, and the management data is associated with the display format stored in said computing apparatus and is then processed so as to be displayable on a display.

17. Construction material management data recording system according to claim 4, wherein the system comprises a computing apparatus being connectable with the reader-writer, and the management data is associated with the display format stored in said computing apparatus and is then processed so as to be displayable on a display.

18. Construction material management data recording system according to claim 5, wherein the system comprises a computing apparatus being connectable with the reader-writer, and the management data is associated with the display format stored in said computing apparatus and is then processed so as to be displayable on a display.

19. Construction material management data recording system according to claim 8, wherein the system comprises a computing apparatus being connectable with the reader-writer, and the management data is associated with the display format stored in said computing apparatus and is then processed so as to be displayable on a display.

20. Construction material management data recording system according to claim 9, wherein the system comprises a computing apparatus being connectable with the reader-writer, and the management data is associated with the display format stored in said computing apparatus and is then processed so as to be displayable on a display.
